(19) United States
(12) Patent Application Publication
(10) Pub. No.: US 2026/0251554 A1
(43) Pub. Date: Aug. 27, 2026

(54) FLOW CELL FOR OPTICAL SPECTROSCOPY, AND METHOD FOR MONITORING BIOTECHNOLOGICAL PROCESSES

(71) Applicant: SCHOTT AG, Mainz (DE)

(72) Inventor: Christian OTT, Landshut (DE)

(73) Assignee: SCHOTT AG, Mainz (DE)

(21) Appl. No.: 18/992,827

(22) PCT Filed: Aug. 9, 2023
(86) PCT No.: PCT/EP2023/072007

§ 371 Date: Jan. 9, 2025

(30) Foreign Application Priority Data
Aug. 17, 2022 (DE) 10 2022 120 732.3

(51) Int. Cl. G01N 21/25; G01N 21/85

(52) U.S. Cl. CPC G01N 21/255; G01N 21/85

(57) ABSTRACT

A flow cell for optical spectroscopy is provided with a housing having a cavity which forms a measuring chamber, inlet and outlet channels and an optical window which seals an opening of the measuring chamber. The optical window is connected to the housing by melting a glass connecting element. A recess is formed around the opening and a supporting surface for the optical window is formed around the opening, so that the optical window contacts the housing at the supporting surface. The use of such a flow cell in processes monitoring of biotechnological processes and methods is also disclosed.

The invention relates to a flow cell for optical spectroscopy, comprising a measurement chamber having an optical window, a feed channel and a drain channel. Further aspects of the invention relate to the use of such a flow cell for monitoring a biotechnological process, and to a method of monitoring a biotechnological process.

### PRIOR ART

Optical spectroscopy is used in many fields of industry and may be used, for example, in order to examine samples or to monitor production processes. This involves introducing light into a sample and analyzing light reflected or transmitted by the sample.

One field of use for optical spectroscopy is monitoring of biotechnological processes. These can be roughly divided into “upstream” processes and “downstream” processes. The upstream processes comprise, in particular, the providing of starting materials, the culturing of cells and the conducting of fermentation processes. The downstream processes comprise, in particular, the separating and purifying of the products obtained and quality control. Raman spectroscopy is particularly suitable for monitoring of such biotechnological processes.

In the case of liquid samples or in the case of samples dissolved or suspended in a liquid, a flow cell may be used for the spectroscopy procedure. The flow cell comprises a measurement chamber with a feed channel and a drain channel and an optical window.

WO2021/198427 describes a flow cell arrangement for use in process monitoring of a biological process. The flow cell arrangement comprises a monolithic cast glass body surrounding a measurement channel, and securing means with an aligning aid for alignment of a sensor head. The glass body is manufactured from a material transparent to UV light, for example quartz glass, and the measurement channel surrounded thereby has at least one straight section with a constant cross section.

A disadvantage of this flow cell arrangement is that the quartz glass customarily used produces unwanted signals in various measurements, especially in Raman spectroscopy, which distort the measurement. WO2021/198427 does enumerate other materials such as sapphire as possible alternatives to quartz glass. However, sapphire in particular is unsuitable for the casting of a glass body, and so it is not possible to use this material to manufacture a monolithic body that gives hermetically tight sealing of the measurement channel.

EP3610244B1 discloses a liquid cell having a measurement chamber and a measurement window, where a contact pressure element presses the measurement window against a seal and hence seals the measurement chamber. The seal may be designed in the form of an O ring or of a film, for example made of PTFE. One disadvantage here is that deposits can occur in small dead volumes that can form in the region of the seal. Furthermore, especially in the case of thick seals, as in the case of an O ring, the exact position of the measurement window is difficult to define. However, an exactly defined distance between the focus in optical spectroscopy and the measurement window is desirable for good signal quality.

With regard to the prior art, one object of the invention can be considered that of providing a flow cell for optical spectroscopy applications, especially in the biotechnology sector, which has a measurement chamber, the material of which does not create an inherent measurement signal in the spectral range examined during a spectroscopic analysis.

In particular, no inherent disruptive measurement signal is to be created in the range between 50 cm⁻¹ and 3800 cm⁻¹. Furthermore, the material thereof is to be compatible with the biological processes being examined or monitored. The measurement chamber, especially in the case of Raman spectroscopy, is to enable a good signal-to-noise ratio.

### DISCLOSURE OF THE INVENTION

A flow cell for optical spectroscopy is proposed. The flow cell comprises a housing having a cavity that forms a measurement chamber, a feed channel, a drain channel and an optical window that closes an opening in the measurement chamber. It is further envisaged that the optical window is bonded to the housing by fusion of a glass bonding element. It is preferably the case here that a depression is formed around the opening and a contact surface for the optical window is formed around the opening and is where the optical window makes contact with the housing.

In particular, the proposed bonding of the optical window to the housing by fusion of a glass bonding element achieves a hermetically tight bond. What is meant here by “hermetically tight” is that the bond between the optical window and the measurement chamber has a helium leak rate of less than 1·10⁻⁵ mbar·I/sec and preferably in the range of 1·10⁻¹⁰ mbar·I/sec to 1·10⁻⁶ mbar·I/sec. The helium leak rate is preferably measured to DIN EN60068-2-17:1995-05, ASTM F2391-05 (Reapproved 2016), or MIL-STD-883 rev. K—method 1014.15. Advantageously, the specified leak rates are in each case also achieved in a test over a duration of at least 4 minutes. The bonding of the optical window is thus especially also sterile-tight, such that no microbes can get into the interior in biotechnological processes.

The proposed bond between the optical window and the measurement chamber or the housing of the flow cell additionally does not require any further components, in particular any elastic elements such as elastomer seals. Such elastomer seals, for example in the form of O rings, do not permit exact positioning of the optical window in relation to the measurement chamber or a housing of the flow cell, especially since the instantaneous thickness thereof is dependent on the contact pressure, and lead to dead volumes that are inaccessible to the flow. The proposed bond, by contrast, is rigid and defines a fixed spatial relationship between a surface of the optical window and the measurement chamber. This is advantageous especially when optical studies are being conducted and a focus of an optical system is to be at a defined distance from a surface of the optical window that faces the interior of the measurement chamber.

A contact surface for the optical window is preferably formed around the opening of the measurement chamber, which is where the housing makes contact with the optical window, where a width of the contact surface of the optical window is narrower than 0.3 mm, preferably narrower than 0.2 mm and more preferably narrower than 0.1 mm. The fusion to the housing establishes an intimate, gapless bond between the glass bonding element and the housing and between the glass bonding element and the optical window. In the region of the contact surface where the optical window makes contact with the housing, it would however optionally be possible for a small gap to remain, in which case the volume within this possible gap is kept as small as possible by the minimizing of the contact surface. But a certain width of the contact surface is desirable in order firstly to simplify the assembly of the optical window, since the contact surface provides a mechanical stop for the exact positioning of the optical window. Secondly, in the fusion of the glass bonding element, the material of the glass bonding element can flow, but flow of the material of the glass bonding element into the interior of the measurement chamber is undesirable. In the optimal case, the material of the glass bonding element will flow into any gap that exists between the optical window and the housing so as to exactly fill volume of the gap, but no material of the glass bonding element will flow beyond the gap into the interior of the measurement chamber. For this purpose, it is preferable when a width of the contact surface is at least 0.02 mm, more preferably at least 0.05 mm and most preferably at least 0.1 mm. For example, a width of 0.1 mm is chosen for the contact surface.

A depression is preferably formed in the housing around the opening, where the glass bonding element fills a space between the optical window and a wall of the depression, such that no gap remains between the wall of the depression and the glass bonding element.

The diameter of the depression is preferably chosen so as to be between 20% and 35% larger than the diameter of the optical window. Preferred widths of the gap in which the glass bonding element is accommodated are thus in the region of 0.6 mm and 1.0 mm. A minimum width of the gap is advantageous in order to be able to transmit compression forces from the wall of the opening to the optical window. In the case of very small widths, however, it becomes increasingly difficult to reliably manufacture the glass bonding element.

The glass bonding element preferably concludes flush with the depression. Furthermore, it is preferable that the optical window has a flush connection to the glass bonding element, such that the two are collectively in a flush arrangement with the depression. Alternatively, however, it may also be the case that the window and/or the glass bonding material does not conclude flush with the depression. In particular, it may be the case here that the glass bonding material is set back and hence is protected from mechanical influences by the protruding housing.

The optical window is preferably bonded to the housing, especially a wall of a depression in the housing that adjoins the opening, by means of a glass bonding element consisting of a glass solder or in the form of a shaped glass body. In the case of a metallic material for the housing, melting of the glass material of the glass bonding element can then form a hermetically tight bond in the form of a glass-to-metal seal (GTMS). In this case, the glass material of the glass bonding material also enters into a chemical bond with the material of the housing, especially with metal oxides at the surface of the metallic housing material. If a ceramic material is chosen for the housing, the constituents of the ceramic are typically meltable directly by the molten glass material, such that a chemical bond is formed in this case too between the glass bonding element and the housing in the fusion.

The shaped glass body may, for example, first be provided in the form of a compact or sintered body obtained from a glass powder, and then fused to the housing and the optical window via a thermal treatment in order to form the glass bonding element. The compact may contain a binder in addition to the glass powder for stabilization, which is removed again at a later stage in the thermal treatment. The thermal treatment can be effected, for example, by heating the arrangement formed from housing, shaped body and optical window in a kiln. Alternatively, for example, a laser can be used to heat the shaped glass body in a controlled manner, such that regions of the housing or of the optical window that do not directly adjoin the shaped glass body are heated only slightly, if at all. In this way, it is possible to avoid any change in the respective materials via the thermal effect.

The glass bonding element consists of or preferably comprises a glass material selected for use in the flow cell such that it is stable to the media introduced into the measurement chamber and also releases a minimum level of substances to these media. Correspondingly, the glass material is preferably stable to water, acids and alkalis.

Glass materials having high chemical stability are typically high-melting glasses and have a higher melting temperature and higher glass transition temperature T_{g} than low-melting glasses having low chemical stability. It is also the case that customary low-melting glasses frequently include heavy metals that are undesirable especially in connection with biotechnological applications.

Accordingly, it is preferable to select the glass bonding material such that it contains or comprises high-melting glass material. High-melting glass materials are considered here to be those that have a glass transition temperature T_{g} of more than 470° C., preferably more than 500° C., more preferably more than 600° C., especially preferably more than 750° C.

Combined with the high glass transition temperature T_{g}, these high-melting glass materials additionally have a low dynamic viscosity on heating, such that fusion causes the glass material to have only low flowability compared to low-melting glasses. This flowability can be improved by further heating, but the effect of significant heat is stress on the other materials that are joined to form the flow cell, such that there is a deterioration in particular in the surface quality thereof. It is therefore preferable to choose glass materials having a glass transition temperature Tg below 900° C., more preferably below 800° C.

In order to avoid deterioration in the surface quality, especially to the inner walls of the measurement chamber, the glass material of the glass bonding element is preferably selected such that it has at least a dynamic viscosity η of 1·10⁵ dPa·s at a temperature of 1300° C. This value is more preferably already attained at 1200° C. and most preferably already attained at 1100° C. Accordingly, the fusion is preferably conducted at a temperature of less than 1300° C., more preferably less than 1200° C. and most preferably less than 1100° C. The dynamic viscosity of the glass or the temperature at which the required viscosity is attained may be determined, for example, according to DIN ISO 7884-1:1998-02.

A dynamic viscosity η of 1·10⁵ dPa·s is too viscous to generally achieve reliable fusion solely via the free flow of the glass material. Consequently, it is preferable to assist the flow of the glass material by applying force, for example via a weight on top or a die. In conjunction with such an active force, the glass material, even in the case of a dynamic viscosity of 1·10⁵ dPa·s, is capable of adapting to the optical window and the wall of the opening and of establishing a good bond.

If the glass bonding element is provided in the form of a compact for the fusing operation, the providing of a mechanical stop by the contact surface is particularly advantageous since the optical window is then supported during the fusing operation by the inside of the flow cell and it is only in this way that pressure can be exerted on the compact.

The glass solder or glass material of the shaped glass body is preferably selected from a borosilicate glass. For example, the chemically resistant glasses 8326 and 8800 from SCHOTT AG are suitable.

The material of the housing is preferably selected from a metal or a metal alloy. Alternatively, the material of the housing is preferably selected from a ceramic. More preferably, the material of the housing is selected from a steel, especially a stainless steel, an austenitic or a ferritic steel, an austenitic-ferritic duplex steel, a nickel-copper alloy, a nickel-chromium-iron-niobium-molybdenum alloy, a nickel-chromium-molybdenum-tungsten alloy, a zirconium-niobium alloy, a titanium-niobium alloy.

A suitable stainless steel is or comprises, for example, AISI 316L “pharmaceutical steel” (materials number 1.4404). This pharmaceutical steel is an austenitic stainless steel.

AISI 329A is a suitable austenitic-ferritic duplex steel (materials number 1.4462).

Preferred ceramic materials for the housing especially include porcelains, yttrium oxide (Y2O3), zirconium oxide (ZrO2) (optionally stabilized with CaO, MgO, CeO2, TiO2, or Y2O3), magnesium aluminate (MgAl2O4), aluminum oxide (Al2O3), SiAlON-Al2O3 and silicon carbide (SIC). The ceramic materials are preferably in polycrystalline form, and so they are preferably opaque.

If a stainless steel is selected, the surface thereof has preferably been passivated. For example, for this purpose, it is possible to form a passivation layer by a chemical or electrochemical surface treatment.

The inner walls of the measurement chamber are preferably formed so as to have only low roughness. The average roughness value Ra is preferably less than 0.8 μm, more preferably less than 0.5 μm.

In combination with the proposed fusion at a relatively low temperature for high-melting glass materials, the material of the measurement chamber is conserved, and so the high quality of the surface is maintained. If, for example, a stainless steel is selected as material for the inner walls of the measurement chamber, in the case of excessively high processing temperatures, damage to the surface is possible as a result of abrasion by brittle metal oxide layers. For example, martensitic Fe—Cr alloys form a brittle upper FeOx layer on a (Fe, Cr)Ox sublayer, such that there are surface changes even in the case of temperatures above >1100° C., and significant surface damage occurs when the temperature is increased further.

For high surface quality of the inner wall of the measurement chamber, at least the component of the housing that forms the inner walls of the measurement chamber is preferably in one-piece form, and accordingly has no gaps, bonding materials, or surface changes caused by welding. The entire housing is preferably in one-piece form.

In order to meet the strict demands for the production of biopharmaceuticals, the material should preferably be selected such that it meets each of the following standards:
i) FDA approved materials e.g. ICH Q7, CFR 211.65(a)—Code of Federal Regulations, USP <88> Class VI, animal derivative free, bisphenol A free
ii) Sectoral chemical resistance-ASTM D 543-21
iii) Biocompatibility e.g. referred to US Pharmacopeia or tests referred to ISO 10993-1 (2018-08).

The material of the optical window is preferably selected from a glass, especially a quartz glass or a borosilicate glass, a crystal, especially a monocrystalline crystal, especially sapphire, a ceramic, especially yttrium-doped zirconium dioxide (yttrium-stabilized zirconia, YSZ), or a glass ceramic.

Further examples of suitable materials include yttrium-doped alumina, lanthanum-doped yttria, aluminum-doped aluminum nitride and magnesium-doped alumina. The dopants in each case are metal oxides.

The optical window may additionally include one or more coatings or shells, in order to modify the mechanical properties, for example a hardness of the surface, and/or optical properties, for example reflection properties. In particular, an antireflection coating may be provided. The antireflection coating is preferably optimized for the wavelength of the excitation light and/or the signal (especially the fluorescence light in the case of fluorescence spectroscopy). The coating(s) may be disposed on both sides, i.e. one on a side of the optical window that faces the interior of the measurement chamber and one on a side facing outward. Alternatively, the coating(s) may be disposed only on one side, or different coatings may be disposed on the two sides. For example, the side facing the interior of the measurement chamber may be free of coatings or only the side facing outward may be coated. This prevents the material of the coating from coming into contact with the media to be examined. If only the outside is coated, this in particular does not have to be chemically stable to the media to be examined. In addition, in general, it is possible to dispense with an antireflection coating on the inside since there are typically only small reflection losses at the transition between the optical window and the liquid medium in the measurement chamber.

In one embodiment of the flow cell, a first coefficient of thermal expansion of the housing is matched to a second coefficient of thermal expansion of the glass bonding element and to a third coefficient of thermal expansion of the optical window. What is meant here by “matched” is that the coefficients of thermal expansion differ by less than 3·10⁻⁶ K⁻¹, preferably by less than 2·10⁻⁶ K⁻¹, more preferably by less than 1·10⁻⁶ K⁻¹.

Alternatively, compression sealing may be envisaged, where a first coefficient of thermal expansion of the housing is greater than a second coefficient of thermal expansion of the glass bonding element and the first coefficient of thermal expansion is preferably greater than a third coefficient of thermal expansion of the optical window. It is preferable here that the first coefficient of thermal expansion differs from the second and, if appropriate, from the third coefficients of thermal expansion by 3·10⁻⁶ K⁻¹ or more, more preferably by 6·10⁻⁶ K⁻¹ or more.

For an optical window made of sapphire, such compression sealing may be obtained, for example, for a housing made of a stainless steel and a glass bonding element made of a borosilicate glass. The first coefficient of thermal expansion of the housing in the case of selection of an austenitic stainless steel may, for example, be 16·10⁻⁶ K⁻¹, the second coefficient of thermal expansion in the case of borosilicate glasses, for example, may be in the range from about 3·10⁻⁶ K⁻¹ to about 7·10⁻⁶ K⁻¹, and the third coefficient of thermal expansion for sapphire is about 5·10⁻⁶ K⁻¹. In this example, the second and third coefficients of thermal expansion differ by less than 3·10⁻⁶ K⁻¹ and hence have been matched to one another. The first coefficient of thermal expansion differs from the two by more than 6·10⁻⁶ K⁻¹ and hence leads to a compressive force exerted by the housing which is transmitted here by the glass bonding element to the optical element.

In the case of such compression sealing, with reference to a longitudinal axis of the opening, shrinkage of the housing after sealing results in action of compressive forces on the glass bonding element and on the optical window, which counteract gap formation between the respective elements and hence promote hermetic sealing. In the case of isotropic thermal expansion, however, compressive forces also act in a direction parallel to the longitudinal direction of the opening, which are not required for this advantageous effect. These forces that act in an axial direction can have an adverse effect on the optical element, especially when this has been assembled from multiple components or layers. One example of this is an optical element composed of yttrium-doped zirconium dioxide, ensheathed with a layer consisting of yttrium oxide. The compressive forces that act in the axial direction would be able to cause detachment of the sheath.

Especially in such cases, it is preferable when the housing is configured such that it has anisotropic thermal expansion, where the first coefficient of thermal expansion is in a direction at right angles to a longitudinal axis of the opening and a further coefficient of thermal expansion of the housing in a direction parallel to the longitudinal axis of the opening has a magnitude of below 1·10⁻⁶ K⁻¹, preferably of below 0.1·10⁻⁶ K⁻¹, more preferably of below 0.01·10⁻⁶ K⁻¹ and yet more preferably of below 0.001·10⁻⁶ K⁻¹.

Such a housing with anisotropic thermal expansion may be executed, for example, as a component made of a titanium-niobium alloy that has been modified by a thermomechanical method. In this thermomechanical method, the alloy constituents are first homogenized, for example by a thermal treatment at a temperature between 900° C. and 1100° C. for a period of 1 to 3 hours in an N2 or Ar atmosphere. Subsequently, the material structure and especially the phase transitions in the material of the component can be undertaken by means of a cold rolling step. The cold rolling step may be followed by annealing at 700° C. to 950° C. for a period of 0.25 to 1 hour. In addition, a water quenching step may be envisaged. An adaptation step can be used to match or specifically alter the coefficient of thermal expansion, especially the first coefficient of thermal expansion and the further coefficient of thermal expansion, over one or more thermal cycles.

Alternatively, for this purpose, the component may be obtained by an additive manufacturing method (3D printing), where the component is obtained layer by layer, for example, by application of metal powder and subsequent sintering. In this case, for example, it is also possible by use of titanium and niobium powder in varying amounts to influence a gradient of the composition of the resultant titanium-niobium alloy. In addition, by controlling the heat input in the course of sintering, especially the temperature and the rate for the heating and cooling, the formation of the various phases in the material can be influenced in order to specifically control the thermal expansion of the component.

One example of a composite element comprising such an outer component composed of a titanium-niobium alloy and an inner component composed of yttrium oxide-ensheathed yttrium-doped zirconium dioxide is known from DE 10 2019 115 204 A1.

The materials for the measurement chamber, the wall of which is preferably formed by the housing of the flow cell itself, the optical window and the materials used for bonding of the optical window to the measurement chamber are thus preferably selected such that they are compatible with biotechnological processes.

In the case of such a material selection, the measurement chamber is free of materials that hinder the growth of cell cultures, create inherent spectroscopy signals in the respective spectral range or are unwanted for other reasons in the processes conducted. For example, gold alloys that are used in the prior art for production of compression seals for windows or are present in gold solders are undesirable in many biotechnological processes. Accordingly, gold alloys are materials that are unwanted in the region of the measurement chamber.

Thus, the flow cell is preferably free of gold alloys in particular, especially gold solders containing gallium, tin and/or germanium, and/or free of materials that create inherent spectroscopy signals on excitation with a spectroscopy light source, especially with a light source such as an LED or a LASER having a wavelength of 532 nm, 633 nm, 775 nm, 785 nm, 830 nm or 1064 nm. More preferably, no spectroscopy signals should occur on excitation with light having a wavelength of 532 nm, 785 nm or 1064 nm, and it is particularly preferable that the materials do not give any spectroscopy signal on excitation with light of wavelength 532 nm or 785 nm.

What is meant here more particularly by “giving an inherent spectroscopy signal” is the emitting or scattering of light having a wavelength different from a wavelength of the excitation light or of the light source, for example as a result of inelastic scattering of light (as, for example, in the case of Raman spectroscopy) or as a result of absorption and re-emission of light (as, for example, in the case of fluorescence spectroscopy). Hydrogen-containing compounds in particular such as plastics can produce inherent spectroscopy signals on excitation with wavelengths of relevance to spectroscopy.

Correspondingly, it is especially preferable when the flow cell, especially in the region of the measurement chamber, is free of hydrogen-containing compounds such as plastics in particular. Advantageously, this is achieved in the flow cell proposed especially when the material of the housing is a metal, metal alloy or ceramic, the optical element consists of glass, glass ceramic, ceramic or a crystal, and the glass bonding element is used to bond the optical window to the housing.

In the case of the preferred material selection for the flow cell and especially for the measurement chamber of the flow cell, the region illuminated on performance of optical spectroscopy is free of materials that emit spectroscopy signals on excitation with light. This means that the proposed flow cell is suitable for spectroscopy studies and especially for the performance of fluorescence spectroscopy. The proposed flow cell is additionally of particularly good suitability for the performance of Raman spectroscopy since no fluorescence signals that disrupt this are created by the materials used in the region of the measurement chamber.

The proposed flow cell, in the case of the preferred material selection, is free of materials that inhibit or disrupt biotechnological processes. This enables the use of the flow cell for continuous monitoring of such processes, where the flow cell is connected temporarily or permanently to the system.

Especially in the case of use of equipment for biotechnological applications, a distinction is typically made between designs for multiple use (multiuse) and for single use. Embodiments for multiple use are configured such that they have prolonged stability to the conditions used in sterilization methods. For example, in the case of designs executed for steam sterilization, the materials selected must be stable in respect of the used temperatures and reagents, such as steam, sodium hydroxide or ethylene oxide.

In embodiments for single use, by contrast, it is merely necessary for the materials selected for this design to permit a single sterilization. For example, it is possible to sterilize customary plastics once under the action of radiation such as gamma radiation, beta radiation or x-radiation.

The proposed flow cell may have a housing made of a metal or ceramic, such that the flow cell can be repeatedly sterilized without difficulty and hence is suitable in particular for multiple use (multiuse). Of course, however, it is also possible to use the proposed flow cell just once (single use).

The proposed flow cells having a housing made of metal are especially suitable for autoclaving. The flow cell is preferably configured such that it is autoclavable 10 000 times by a steam treatment at 141° C. “Autoclavable” in the context of this description also means autoclavable in the sense of DIN EN ISO 14937; EN ISO 17665, which applies to medical devices.

The proposed flow cell is also of particularly good suitability for sterilization using radiation, and is preferably suitable for sterilization with a dose of 100 kGy.

Flow cells having a housing made of metal are also particularly pressure-resistant in conjunction with the hermetically tight encapsulation of the optical window in accordance with the invention. Preference is given to selecting the thickness of the housing material and the thickness of the window such that the flow cell is stable to an internal pressure in the measurement chamber of at least 10 MPa (100 bar).

The housing that forms the measurement chamber of the flow cell may additionally have been overmolded with a polymer or plastic to form a shell. The shell here may fully or at least partly encase the housing, leaving the connections for access to the measurement chamber clear even in the case of full encasement. The shell may be configured such that functional elements are formed thereon, for example mounts, aligning means or connectors. For example, a port having an outer thread may be provided as a combined retaining and aligning means, where the port has been provided on a wall that faces inward with lands for alignment and exact positioning of a sensor head of a spectrometer. Suitable polymers for the shell especially include polyolefins such as polyethylene.

The optical window of the flow cell may be executed with planar surfaces or may be formed, for example, such that it acts like a lens. Accordingly, it is preferable to select the shapes of the surfaces of the optical window from a planar surface, a convex surface, a concave surface or combinations thereof, such as biconvex, planar-convex, convex-concave, planar-concave and biconcave.

In order to simplify mechanical connection to a spectrometer or a sensor head of a spectrometer, the proposed flow cell may have corresponding auxiliaries. Such auxiliaries may serve to establish a releasable mechanical connection, especially for retention of a spectrometer or a sensor head, and/or for exact and reproducible alignment in relation to the position of the optical window of the flow cell. The retaining means are preferably set up such that a releasable connection is established.

The flow cell preferably comprises, as auxiliaries, at least one retaining means for retention of a spectrometer or a sensor head of a spectrometer and/or at least one aligning means for alignment of a spectrometer or a sensor head.

It is preferable here that the flow cell and the retaining means and/or the aligning means are configured such that the spectrometer or sensor head is mountable on the flow cell such that there are no components disposed between the optical window and the first optical element of the spectrometer or sensor head. In particular, it is preferable when there are no optical fibers such as glass fibers disposed between the optical window and the first optical element of the spectrometer or sensor head. The first optical element of the spectrometer or sensor head may especially be an entry opening or entry aperture or a first lens.

This enables the use of a free-beam optical unit for connection of a spectrometer to the flow cell proposed.

Alternatively, it may be the case that retaining means and/or aligning means for retaining or alignment of an optical fiber such as a glass fiber are disposed on the flow cell. These glass fibers may in turn be used for establishment of an optical connection to a spectrometer.

Preferably, the at least one retaining means and/or the at least one aligning means are set up to interact with a counterpart on the spectrometer or sensor head for a releasable snap-fit connection. Such a snap-fit connection may be brought about, for example, by a snap-fit element that meshes in a releasable manner into a depression on the respective other component.

In addition, the retaining means and/or the means of alignment may be configured, for example, as a flange, as depressions, for example holes, as elevations, for example studs, as threaded holes, as a groove and combinations of these means. Corresponding counterparts are preferably provided on the sensor head or the spectrometer in order to interact with these retaining means and/or aligning means. The retaining means may also be designed to work together with an additional fixing means, for example screws or clamps.

In addition, the retaining means may especially be designed as a bayonet closure, in order to establish a releasable connection between the flow cell and a spectrometer or sensor head via an insert-and-rotate movement.

The retaining means may especially also be designed and arranged in order to establish a defined distance between an entry aperture of the spectrometer or sensor head and the flow cell, especially the optical window of the flow cell. This distance may advantageously be standardized between various measurement means such as flow cells, ports or other sensor receptacles such that a spectrometer or sensor head can be connected to the flow cell via the retaining means without further adjustments. In this way, for example, it is possible to use a single spectrometer for a multitude of measurement means and to change them over rapidly.

The retaining means and/or the aligning means may be in one-piece form with the housing of the flow cell or may be part of the housing of the flow cell. Alternatively, the flow cell may comprise an adapter which is releasably or fixedly mounted on the flow cell. Further retaining means and/or further aligning means that are part of the adapter can then establish a releasable connection to a spectrometer or a sensor head. If the flow cell comprises a polymer shell, the retaining means and/or aligning means may also be part of this polymer shell.

The flow cell is advantageously configured by means of the mechanically robust and hermetically tight sealing of the optical window such that a spectrometer or sensor head retained on the flow cell or accommodated in an adapter or a retaining means of the flow cell is releasable and can be exchanged while maintaining the integrity of the window. In this way, various measurements are possible without disrupting or even contaminating the medium present in the flow cell.

For the introduction or discharge of a medium or fluid into the measurement chamber of the flow cell, the flow cell has a feed channel and a drain channel. The feed channel and the drain channel are preferably arranged opposite one another on a common axis, such that a laminar flow forms within the measurement chamber when a medium flows through. Alternatively, the feed channel and the drain channel are arranged on different axes from one another, such that a turbulent flow forms within the measuring chamber when a medium flows through. If a turbulent flow is desired, it is preferable to arrange the feed channel and drain channel such that they run tangentially to the radius of a measurement chamber. The measurement chamber may be designed here, for example, as a hole.

The feed channel and/or the drain channel preferably open into terminals for connection to hoses or tubes in order to enable integration of the flow cell into a liquid stream to be examined. For example, it is possible for this purpose to provide screw connections or hose nipples.

The medium may, for example, be a liquid in which solids may be suspended. A laminar flow regime achieves particularly calm and uniform flow of the medium within the measurement chamber, while making it possible to largely avoid dead volumes with zero or considerably lower flow. In the case of turbulent flow, good mixing of all components of the medium is achieved, in particular without allowing entrained or suspended solids to settle out. Accordingly, embodiments of the flow cell with an arrangement for turbulent flow are preferred for uses with suspensions. Arrangements of the flow cell that are designed for turbulent flow also enable particularly representative measurements on the medium since the occurrence of troublesome deposits is suppressed.

A further aspect of the invention is the use of one of the flow cells proposed here for monitoring a biotechnological process.

It is particularly advantageously possible to use the flow cell for the monitoring of perfusion cultures, where a cell culture is constantly purged by a flow of medium. A substream or secondary stream of the flowing medium may be passed here through the flow cell and continuously optically analyzed. It is possible in this way, for example, to permanently monitor the concentration of nutrients, the presence of growth factors or the concentration of metabolism products, and to influence the process regime depending on these monitored parameters.

A further aspect of the invention is the providing of a method of monitoring a biotechnological process, wherein the process comprises circulation of a medium for culturing of cells and flow through a vessel for accommodation of the cell culture. In the method, the flowing medium is divided into a main stream and a secondary stream, the secondary stream is conducted through a flow cell as described herein, spectroscopic analysis is effected within the flow cell, and then the secondary stream is preferably fed back to the main stream.

It is preferably also the case that the spectroscopic analysis is used to ascertain at least one parameter of the medium examined. This particular parameter is preferably used as a variable in an automated closed-loop control process, in order to regulate at least one parameter of the medium to a predefined target value.

Use of the proposed flow cell or performance of the proposed method can advantageously enable in situ or inline process control. There is no need to open the apparatus for taking of samples. This firstly achieves process monitoring in a constant manner or in very short time intervals. As a result, it is possible to rapidly recognize any changes in the process being monitored and to intervene, for example, via automatic closed-loop control systems. By virtue of the regular parameter monitoring and resultant brief delays, it is especially possible to provide a closed-loop control circuit in order to regulate parameters required in the process to a predefined target value. Thus, the proposed flow cell simplifies or even for the first time enables automation of the biotechnological processes.

Secondly, the proposed flow cell, because of the selection of process-compatible materials, can be fixedly integrated into the apparatus. Opening of the system with the ever-present risk of contamination is advantageously avoided. Sterile integrity of the system is always maintained even during the course of optical analyses.

Advantageously, the proposed flow cell enables exchange of a measurement device used to measure the parameters of the medium without impairment of sterile integrity of the apparatus. Accordingly, the methods and processes may also comprise steps in which a measurement device, such as a spectrometer or a sensor head of a spectrometer, is exchanged during the performance of the method. Accordingly, it is possible in the method to use two or more different measurement devices for detection of one or more parameters of the medium flowing through the measurement chamber of the flow cell.

Using the proposed flow cell, it is possible to optimize the product stream, especially for continuous manufacture. By means of constant automated closed-loop control, an optimized yield is enabled in each process stage, which means that the output of an upstream process stage is in equilibrium with the capacity of a downstream process stage. The reliable and reproducible process regime in each process stage thus makes it unnecessary to provide buffers between the individual process stages and increases the space-time yield, which enables process intensification.

It will be apparent that the features mentioned above and still to be elucidated hereinafter are usable not just in their particular combination specified but also in other combinations or on their own, without leaving the scope of the present invention.

Preferred designs and embodiments of the invention are shown in the drawings and are elucidated in detail in the description that follows, where identical reference signs refer to identical or similar or functionally identical components or elements.

The figures show, in schematic form:

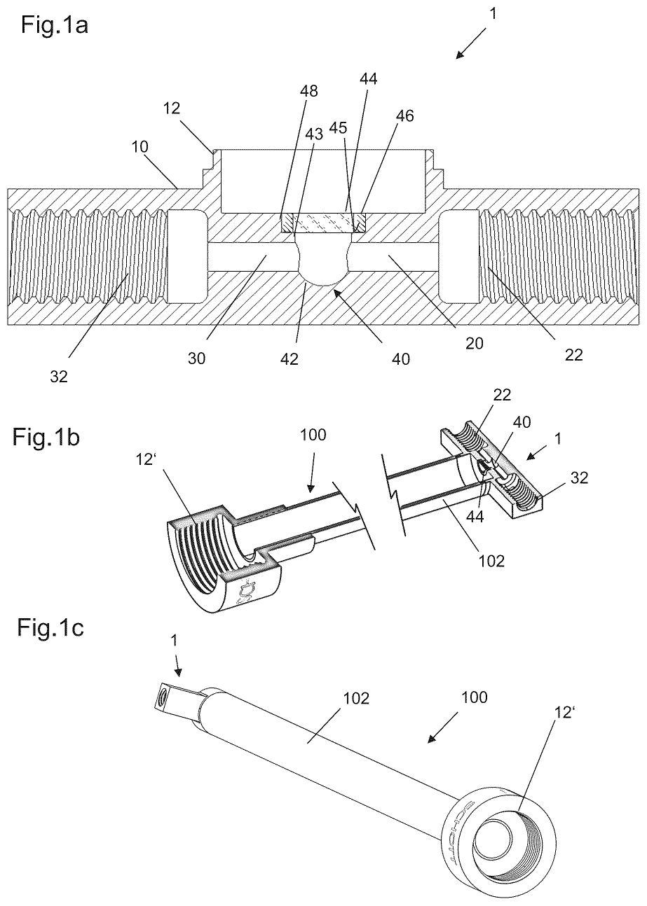

FIG. 1a a first working example of a flow cell in a schematic section view from the side,

FIG. 1b the flow cell from the first working example with an assembly adapter in a perspective section view,

FIG. 1c the flow cell from the first working example with the assembly adapter in a perspective view,

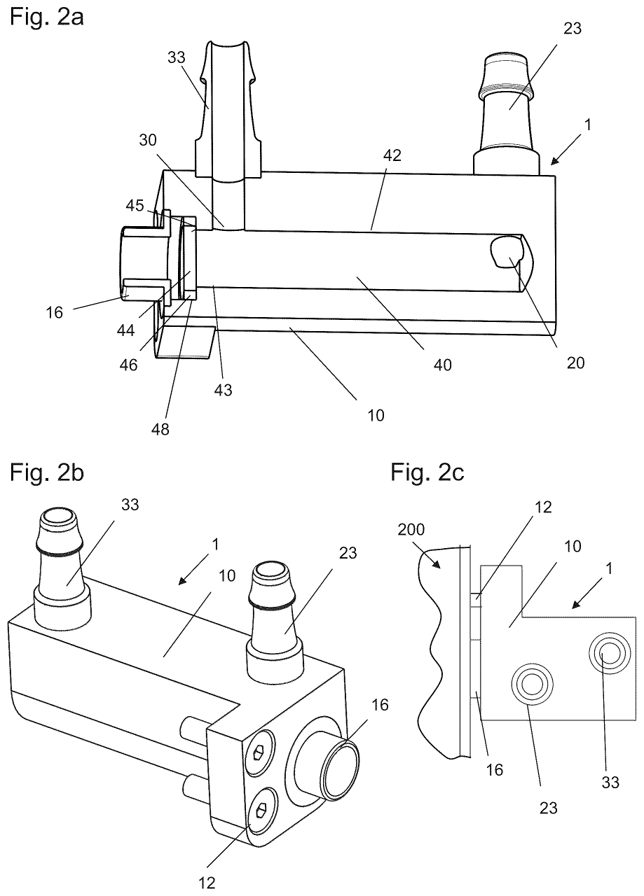

FIG. 2a a second working example of a flow cell in a perspective section view,

FIG. 2b the flow cell from the second working example in a further perspective view,

FIG. 2c the flow cell from the second working example with mounted sensor head in a view from the top,

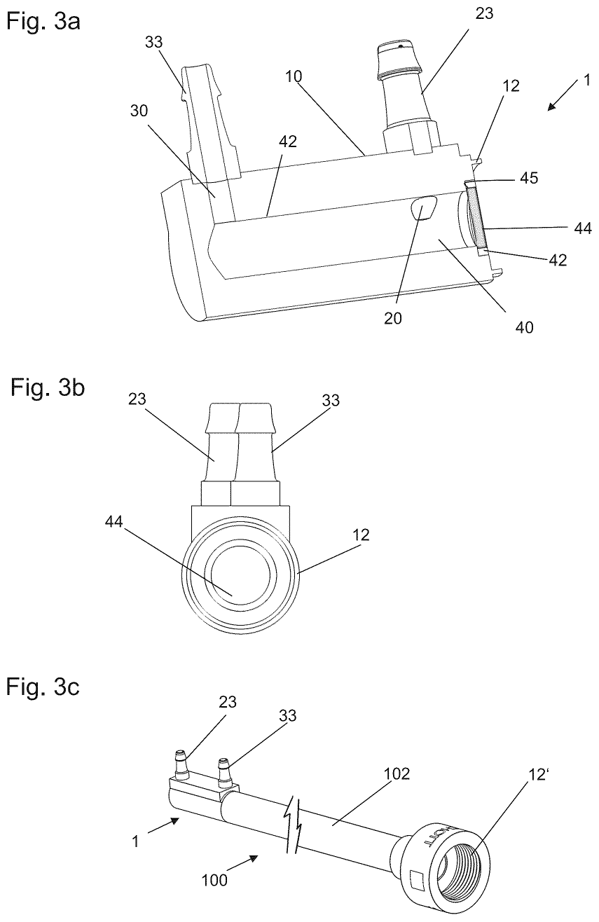

FIG. 3a a third working example of the flow cell in a perspective section view,

FIG. 3b the flow cell from the third working example in a view from the side,

FIG. 3c the flow cell from the third working example with a mounted adapter in a perspective view,

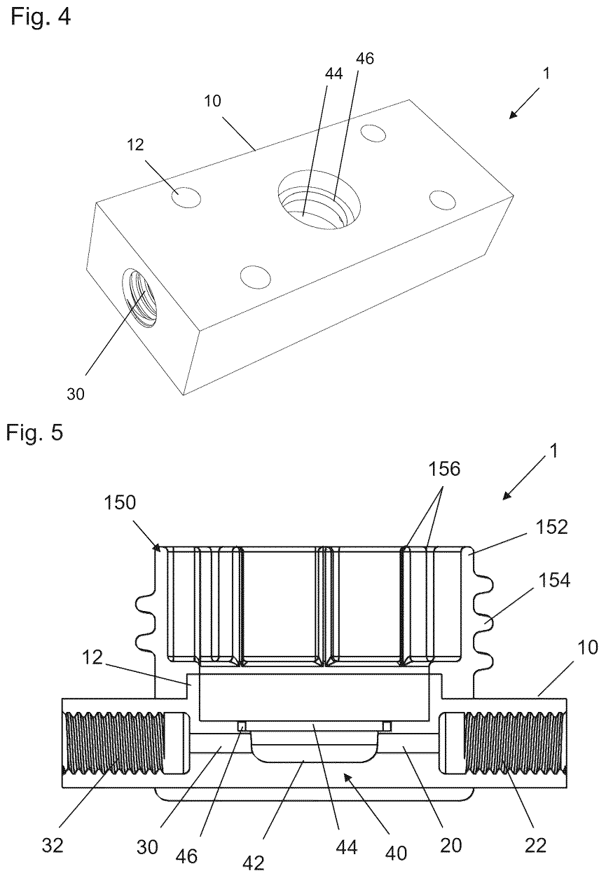

FIG. 4 a fourth working example in a perspective view, and

FIG. 5 a working example of a flow cell with a shell arranged around the housing.

FIGS. 1a to 1c show a first embodiment of a flow cell 1. FIG. 1a shows a first working example of the flow cell 1 in a schematic section view from the side. The flow cell 1 has a housing 10, in the interior of which is disposed a cavity that forms a measurement chamber 40. A feed channel 20 connects the measurement chamber 40 to a first terminal 22, and a drain channel 30 connects the measurement chamber 40 to a second terminal 32. In the working example shown in FIG. 1a, the terminals 22, 32 are executed as screw connections and may be connected, for example, via screw-in connectors to a liquid stream to be examined. In the working example shown in FIG. 1a, the feed channel 20 and the drain channel 30 are arranged opposite one another on the same axis. Such an arrangement is capable of enabling calm laminar flow of a medium through the measurement chamber 40.

The measurement chamber 40, on a side which is at the top in FIG. 1a, is an opening 43 which is closed by an optical window 44. The material of the optical window 44 is selected in accordance with the optical studies to be conducted. For example, for the performance of Raman spectroscopy, preference is given to using an optical window 44 of a quartz glass in UV quality and more preferably an optical window 44 of sapphire glass.

The optical window 44, in the first working example of FIG. 1a, is joined to a wall 42 of the measurement chamber 40 using a glass bonding element 46. The glass bonding element 46 is fused to the optical window 44 and the wall 42, and hermetically seals the opening 43 of the measurement chamber 40. For production of this hermetically sealed bond, a precursor of the glass bonding element 46 in the form of a compact may be provided from a glass powder and may be inserted together with the optical window 44 into a depression 48 in the housing 10. The optical window 44 lies on a narrow contact surface 45 that surrounds the opening 43 on the housing 10. By means of a subsequent thermal treatment, for example in a kiln, or by heating with a laser, the compact is melted and the glass bonding element 46 fused to the optical window 44 and a wall of the depression 48 is obtained.

Advantageously, the bonding of the optical window 44 via the fusion of the glass bonding element 46 results in a defined positional relationship between a surface of the optical window 44 and the measurement chamber 40 or the housing 10 of the flow cell 1. This permits reproducible arrangement of optical instruments such as a spectrometer or a sensor head 200 of a spectrometer (cf. FIG. 2c) in such a way that an optical focus is at a defined distance from a surface of the optical window 44 that faces inward within the measurement chamber 40. In order to further facilitate such a reproducible arrangement, in the working example of FIG. 1a, a flange is provided as retaining means 12 on the housing 10 of the flow cell 1. The flange especially also serves here as an aligning means in the form of a defined mechanical stop with which a spectrometer or sensor head 200 or probe head can be secured in reproducible alignment with the flow cell 1.

The narrow application surface 45 means that the glass bonding element 46 is additionally moved very close to the opening 43, such that there is only a small dead volume, if any, between the optical window 44 and the housing 10. If a width of the contact surface 45 is optimized to the properties of the glass bonding element 46, the glass bonding element 46, during the thermal treatment for the fusing to the optical window 44, will be able to completely or at least virtually completely fill any gaps remaining without penetration of the material of the glass bonding element 46 beyond the edge of the opening 43 into the region of the measurement chamber 40.

If different mechanical retaining means 12 are desired for a connection to a spectrometer or sensor head 200 of a spectrometer, these may be designed differently in accordance with the requirements. In addition, it is possible, as shown in FIG. 1b, to provide an adapter 100.

FIG. 1b shows the flow cell 1 as described with regard to FIG. 1a with an adapter 100 secured to the retaining means 12 executed as a flange. The adapter 100 in turn comprises a further retaining means 12′ for connection to a spectrometer or a sensor head 200. In the example shown, the further retaining means 12′ are designed as an inner thread. As shown in FIG. 1b, such an adapter 100 can especially also be used to exactly and reproducibly fix a distance between the flow cell 1 and an entry aperture of the spectrometer or sensor head 200 that is required for the respective spectrometer or sensor head 200 (cf. FIG. 2c). For this purpose, the adapter 100 may comprise, for example, a tube section 102, where the required distance can be fixed via the choice of length of the tube section 102. In the diagram in FIG. 1b, the tube section 102 is shown by broken lines, in order to make it clear that the length thereof can be adjusted as required.

FIG. 1c shows the arrangement of flow cell 1 and adapter 100 that has been described in relation to FIG. 1b in a further perspective view.

FIGS. 2a to 2c show a second working example of a flow cell 1. FIG. 2a shows the second working example of the flow cell 1 in a perspective section view.

Similarly to the manner described with reference to the first working example of FIG. 1a, the flow cell 1 has a housing 10, in the interior of which is disposed a cavity that forms a measurement chamber 40. The measurement chamber 40 is formed here as a blind hole. A feed channel 20 connects the measurement chamber 40 to a first connection nipple 23, and a drain channel 30 connects the measurement chamber 40 to a second connection nipple 33. The connection nipples 23, 33 are set up for direct connection to hoses that conduct a liquid stream to be examined. In the working example shown in FIG. 2a, the feed channel 20 and the drain channel 30 are disposed on different axes and are not opposite one another. In addition, it is apparent that the feed channel 20 and the drain channel 30 are each arranged such that they run tangentially to the radius of the measurement chamber 40. Such an arrangement is capable of promoting turbulent flow of a medium through the measurement chamber 40, which, for example, ensures good mixing and counteracts deposition of solids.

The measurement chamber 40, on a side which is on the left in FIG. 2a, has an opening 43 which is closed by an optical window 44. The material of the optical window 44 may again be selected in accordance with the optical analyses to be conducted. For example, for the performance of Raman spectroscopy, preference is given to using an optical window 44 of a quartz glass in UV quality and more preferably an optical window 44 of a crystalline material, for example sapphire glass.

As described with reference to the first embodiment of FIG. 1a, the optical window 44 is bonded to a wall 42 of the measurement chamber 40 using a glass bonding element 46. The glass bonding element 46 has been fused to the optical window 44 and the wall of the depression 48 and hermetically seals the measurement chamber 40.

FIG. 2b shows the flow cell 1 of the second embodiment from another perspective. In this view, the retaining means 12 in the form of threaded holes are apparent. For a reproducible connection to a spectrometer or sensor head 200, this can be connected to the threaded holes via corresponding screws. The provision of multiple threaded holes also reproducibly fixes the position and alignment. In addition, in the second working example, an optical aperture 16 is provided. This can interact with corresponding tubular elements of a spectrometer or sensor head 200 (cf. FIG. 2c) and shield a light path between the spectrometer or sensor head 200 and the measurement chamber 40 of the flow cell 1 against ingress of extrinsic light. In addition, the aperture 16 could alternatively form a form fit with appropriate elements on the spectrometer or sensor head 200 and provide similar assistance to the retaining means 12 in the precise alignment from the flow cell 1 to the spectrometer or sensor head 200.

FIG. 2c shows connecting of the flow cell 1 to a sensor head 200 in a view from the top. Only a small detail of the sensor head 200 is shown here. It is apparent in FIG. 2c that the aperture 16 meshes into a corresponding opening in the sensor head 200 and shields a light path between the sensor head 200 and the flow cell 1 from ingress of extrinsic light from the environment. In addition, the aperture 16 has a twin function here as an aligning means and serves to align the sensor head 200 precisely with respect to the flow cell 1. Securing means used here are screws that interact with corresponding threaded holes as retaining means 12 in the housing 10 of the flow cell 1.

FIGS. 3a to 3c show a third working example of the flow cell 1. The third working example corresponds largely to the second working example described with regard to FIG. 2a, except that the retaining means 12 here take the form of a flange and there is no additional aperture 16 provided, since the flange 12 assumes this function here. FIG. 3a shows the flow cell 1 from the third working example in a perspective section view.

FIG. 3b shows the flow cell 1 in a view from the side. In this diagram, it is readily apparent that, in the third working example, the feed channel 20 and the drain channel 30 or the two connection nipples 23, 33 are arranged on different axes, where the axes here run parallel to one another. Alternatively, it would also be possible for the two axes to be arranged at an angle to one another.

FIG. 3c shows the flow cell 1 according to the third working example together with an adapter 100 secured to the retaining means 12 in the form of a flange, for example by means of a weld bond. The adapter 100 has a further retaining means 12′ which, similarly to the manner described with regard to the first working example of FIGS. 1a to 1c, is configured as an outer thread and is disposed at the end of a tube section 102. By means of this outer thread, it is possible, for example, to connect a sensor head 200 (cf. FIG. 2c) to the adapter 100 and hence to the flow cell 1, with definition of and reproducible compliance with a defined distance and a defined alignment of flow cell 1 from the sensor head. The distance may be adjusted here via the choice of length of the tube section 102, with the tube section 102 shown by broken lines in FIG. 3c.

FIG. 4 shows a fourth working example of a flow cell 1 in a perspective view. The construction of the flow cell 1 corresponds largely to the first working example that has been described with regard to FIG. 1a. In a departure from the first working example, the retaining means 12 provided are not a flange, but instead here, by way of example, an arrangement of four holes as retaining means 12. These may especially be designed as threaded holes and enable simple securing of a sensor head 200 or a spectrometer on the flow cell 1. In addition, it will be appreciated that it is possible to provide an adapter 100 and to secure it via the threaded holes in the housing 10 of the flow cell 1 if, for example, different retaining means 12 are required for securing of a particular spectrometer. In this case, the adapter 100 may then be configured such that it has further retaining means 12′ set up for connection to that spectrometer.

FIG. 5 shows a working example of a flow cell 1 having a shell 150 of a polymer material that partly surrounds the housing 10. The diagram is executed as a section view from the side.

The housing 10 is constructed similarly to the manner described with regard to the working example of FIG. 1a and has been produced, for example, from a ceramic material. The measurement chamber 40 is accommodated within the housing 10, where the housing 10 provides the wall 42 of the measurement chamber 40. An opening in the housing 10 is closed by an optical window 44 which is connected to the housing 10 via a glass bonding element 46. The measurement chamber 40 may be connected to a fluid stream via a feed channel 20 and a drain channel 30, with provision of connections 22, 32 for the bonding.

The flow cell 1 shown in FIG. 5, by comparison with the flow cell 1 shown in FIG. 1a, has a shell 150 which preferably consists of a polymer material and may have been produced, for example, by injection molding.

This can be done by inserting the housing 10 of the flow cell 1 into an injection mold and overmolding with the polymer material.

The shell 150 surrounds a section of the housing 10 that comprises the optical window 44, and leaves the regions adjoining the terminals 22, 32 clear.

The shell 150, on the side of the housing 10 in which the optical window 44 has been inset, has a port 152 with a thread 154 formed on the outside thereof. This thread 154, in conjunction with the port 152, serves as a retaining and connecting means for accommodating and fixing a sensor head 200 (cf. FIG. 2c). Several lands 156 are disposed on a wall of the port 152 that faces inward. These lands 156 serve as means for exact positioning and alignment of the sensor head 200. Since the shell 150 together with the port 152 have been produced from a polymer, the material is elastic and flexible. This permits formation of the lands such that they form a friction fit with the sensor head 200 and hence exact and reasonable alignment of the sensor had 200 is ensured.

Although the present invention has been described with reference to preferred working examples, it is not limited to these and is modifiable in various ways.

### LIST OF REFERENCE NUMERALS

1 flow cell
10 housing
12 retaining means
12 further retaining means
16 optical aperture
20 feed channel
22 first terminal
23 first connection nipple
30 drain channel
32 second terminal
33 second connection nipple
40 measurement chamber
42 wall of measurement chamber
43 opening
44 optical window
45 contact surface
46 glass bonding element (glass solder)
48 depression
49 channel
100 adapter
102 tube section
150 shell
152 port
154 screw thread
156 land
200 sensor head

1. A flow cell for optical spectroscopy, comprising a housing having a cavity that forms a measurement chamber, a feed channel, a drain channel and an optical window that closes an opening in the measurement chamber, where the optical window is bonded to the housing by fusion of a glass bonding element, wherein a depression is formed around the opening and a contact surface for the optical window is formed around the opening and is where the optical window makes contact with the housing.

2. The flow cell of claim 1, wherein the width of the contact surface of the optical window is narrower than 0.3 mm.

3. The flow cell of claim 1, wherein the glass bonding element fills a clearance between the optical window and a wall of the depression, such that no gap remains between the wall of the depression and the glass bonding element.

4. The flow cell of claim 1, wherein the glass bonding element comprises a glass material having a glass transition temperature T_{g} of more than 470° C.

5. The flow cell of claim 1, wherein the optical window is bonded to the housing, especially to a wall of a depression in the housing that adjoins the opening, via a glass bonding element that consists of a glass solder or takes the form of a shaped glass body.

6. The flow cell of claim 5, wherein the glass solder or the glass material of the shaped glass body is a borosilicate glass.

7. The flow cell of claim 1, wherein a component of the housing that forms the cavity with the measurement chamber is in one-piece form.

8. The flow cell of claim 1, wherein the average roughness Ra of the inner walls of the measurement chamber is less than 0.8 μm.

9. The flow cell of claim 1, wherein the material of the housing is selected from a metal or metal alloy.

10. The flow cell of claim 1, wherein the material of the optical window is selected from a glass, a crystal, a ceramic, or a glass ceramic.

11. The flow cell of claim 1, wherein a first coefficient of thermal expansion of the housing is greater than a second coefficient of thermal expansion of the glass bonding element.

12. The flow cell of claim 11, wherein the housing has an anisotropic thermal expansion, where the first coefficient of thermal expansion is in a direction at right angles to a longitudinal axis of the opening and a further coefficient of thermal expansion of the housing in a direction parallel to the longitudinal axis of the opening has a magnitude of below 1·10⁻⁶ K⁻¹.

13. The flow cell of claim 1, wherein the shapes of the surfaces of the optical window are selected from a planar surface, a convex surface, a concave surface and combinations thereof.

14. The flow cell of claim 1, wherein the flow cell comprises a shell that at least partly surrounds the housing.

15. The flow cell of claim 1, further comprising retaining means for retention of a spectrometer or a sensor head of a spectrometer and/or aligning means for alignment of a spectrometer or a sensor head.

16. The flow cell of claim 15, wherein the flow cell and the retaining means and/or the aligning means are configured such that the spectrometer or sensor head is mountable on the flow cell such that there are no components disposed between the optical window and a first optical element of the spectrometer or sensor head.

17. The flow cell of claim 15, wherein the retaining means and/or the aligning means are set up to interact with a counterpart on the spectrometer or sensor head for a releasable snap-fit connection.

18. The flow cell of claim 15, wherein the retaining means and/or the means of alignment are designed as a flange, as depressions, as elevations, as threaded holes, as a groove and combinations of these means.

19. The flow cell of claim 1, wherein the feed channel and the drain channel are arranged opposite one another on a common axis, such that a laminar flow forms within the measurement chamber when a liquid medium flows through, or in that the feed channel and the drain channel are arranged on different axes from one another, such that a turbulent flow forms within the measuring chamber when a liquid medium flows through.

20. (canceled)

21. A method of monitoring a biotechnological process, where the process comprises circulation of a medium for culturing of cells and flow through a vessel for accommodation of the cell culture, wherein the flowing medium is divided into a main stream and a secondary stream, the secondary stream is conducted through a flow cell of claim 1, spectroscopic analysis is effected within the flow cell, and then the secondary stream is fed back to the main stream.

22. The method of monitoring a biotechnological process of claim 21, wherein the monitoring comprises using multiple measurement devices for detection of parameters of the medium in the measurement chamber of the flow cell, and these are connected by a retaining means of the flow cell without impairing sterile integrity of the medium.
